(19) United States
(12) Patent Application Publication
(10) Pub. No.: US 2014/0184426 A1
(43) Pub. Date: Jul. 3, 2014

(54) Traffic Camera Detector

(71) Applicant: Otis Fleming, JR., New Orleans, LA (US)

(72) Inventor: Otis Fleming, JR., New Orleans, LA (US)

(21) Appl. No.: 13/729,600

(22) Filed: Dec. 28, 2012

(51) Int. Cl. G08G 1/0967

(52) U.S. Cl. CPC G08G 1/0967
USPC 340/905

(57) ABSTRACT

This invention is an electronic device powered by your vehicle's adaptor or other outside power source, to detect the presence of traffic cameras or radars associated with traffic cameras.

This is an application for a patent for an invention call a Traffic Camera Detector. This is an electronic device powered by your vehicle's adaptor or other outside power source, to detect the presence of traffic cameras or radars associated with traffic cameras.

The invention is designed to promote safety and assist in preventing traffic accidents by alerting motorists prior to reaching a destination where a traffic camera may be installed or in use, so that motorists will not be in a position where they have to come to an immediate halt, or drastically decrease the vehicle's momentum which could cause an accident with other drivers.

1. This device will detect the presence of traffic cameras or radars associated with traffic cameras.
This device will promote safety and assist in preventing traffic accidents.
